(19) United States
(12) Patent Application Publication
(10) Pub. No.: US 2003/0236979 A1
(43) Pub. Date: Dec. 25, 2003

(54) Group security objects and concurrent multi-user security objects

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 10/179,339

(22) Filed: Jun. 24, 2002

(51) Int. Cl. H04L 9/00

(52) U.S. Cl. 713/167

(57) ABSTRACT

Controlling access to a resource for a group of users including creating a group security object in dependence upon one or more user-selected group security control data types, the group security object comprising security control data and at least one security method, the security control data comprising at least one security control user identification; receiving a request for access to the resource; receiving security request data, wherein the security request data includes at least one security request user identification; and determining access to the resource in dependence upon the security control data and the security request data.

### BACKGROUND OF THE INVENTION

1. Field of the Invention

The present invention relates to data processing methods, apparatus, systems, and computer program products therefor, and more particularly to methods, apparatus, systems, and computer program products in support of securing valid authentication and authorization for access to computer resources and other items.

2. Description of Related Art

It is common to use passwords to control access to resources, including everything from documents, to bank accounts, burglar alarms, automobiles, home security systems, personal video recorders, and so on. Passwords often consist of text strings that a user must provide to a security system in order to obtain access to a secured resource. A password provided by a user typically is checked against a stored password to determine a match. If the entered password and the stored password match, access is granted to the resource.

Mechanisms for managing passwords typically are programmed into the software applications with which the passwords are associated. That is, a program external to the password is used to authenticate the password, check to see if the password is about to expire, and determine the access granted. Systems securing resources therefore typically have password management operations coded into them to process and authenticate a specific type of password content. Users have no control over how passwords are defined or used in typical systems securing resources. Moreover, changing the way in which a password is used typically requires changing program code in a system securing resources.

In addition, such systems generally are capable of accepting and administering security with respect only one type of password. If passwords are viewed as one type of security control data, then such systems can be said to function with only one kind of security control data. There is no way in such systems for anyone, especially not a user, to change from a password to some other kind of security control data without substantial redesign and recoding. There is no way in such systems for a user or anyone else to determine to use more than one kind of security control data without substantial redesign and recoding. It would be beneficial to have improved ways of choosing and using security control data to secure resources through computer systems.

### SUMMARY OF THE INVENTION

Embodiments include methods, systems, and products for controlling access to a resource for a group of users including creating a group security object in dependence upon one or more user-selected group security control data types, the group security object comprising security control data and at least one security method, the security control data comprising at least one security control user identification; receiving a request for access to the resource; receiving security request data, wherein the security request data includes at least one security request user identification; and determining access to the resource in dependence upon the security control data and the security request data. Creating a group security object further comprises storing in the group security object a resource identification for the resource; storing in the group security object the user-selected group security control data types and the group security control data; and storing, in the group security object, security control data for each user-selected group security control data type, including the at least one security control user identification.

Embodiments include storing in the group security object an authorization level of access for the resource, wherein determining access to the resource further comprises determining access to the resource in dependence upon the authorization level of access for the resource. In typical embodiments, the group security control data types comprise object oriented classes and storing the user-selected group security control data types comprises storing references to group security control objects instantiated from the group security control data types.

Embodiments include storing in the group security object the at least one security control user identification further comprises storing at least one security control user identification in at least one of the group security control objects. In typical embodiments, the security control data comprises more than one security control user identification, receiving security request data comprises receiving more than one security request user identification, and determining access to the resource comprises validating security request data for all user-selected data types. In typical embodiments, determining access to the resource comprises validating security request data for each user-selected group security control data type having in its security control data a security control user identification equal to the security request user identification.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIGS. 1a, 1b, and 1c set forth block diagrams depicting alternative exemplary data processing architectures useful in various embodiments of the present invention.

FIG. 2 sets forth a data flow diagram depicting exemplary methods of controlling access to a resource, including creating a group security object and receiving a request for access to a resource, and determining whether to grant access to the resource.

FIG. 3 sets forth a data flow diagram depicting an exemplary method of creating a group security object.

FIG. 4 sets forth a class relations diagram including a group security class and a group security control class.

FIG. 5 sets forth a data flow diagram depicting exemplary methods of receiving requests for access to resources.

### DETAILED DESCRIPTION OF EXEMPLARY EMBODIMENTS

### Introduction

The present invention is described to a large extent in this specification in terms of methods for securing valid authentication and authorization for access to computer resources and other items. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product and stored on a diskette or other recording medium for use with any suitable data processing system.

Embodiments of a computer program product maybe implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.” Complex data structures that include member methods, functions, or software routines as well as data elements are referred to as “classes.” Instances of classes are referred to as “objects” or “class objects.”

“Browser” means a web browser, a communications application for locating and displaying web pages. Browsers typically comprise a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

“CORBA” means the Common Object Request Broker Architecture, a standard for remote procedure invocation first published by the Object Management Group (“OMG”) in 1991. CORBA can be considered a kind of object-oriented way of making “RPCs” or remote procedure calls, although CORBA supports many features that do not exist in RPC as such. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages such as C++ and Java look like invocations of local member methods in local objects. Whenever a client program, such as, for example, a C++ program, acquires an object reference, decoded from a stringified object reference, from a Naming Service, or as a result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class.

“CGI” means “Common Gateway Interface,” a standard technology for data communications of resources between web servers and web clients. More specifically, CGI provides a standard interface between servers and server-side ‘gateway’ programs which administer actual reads and writes of data to and from file systems and databases. The CGI interface typically sends data to gateway programs through environment variables or as data to be read by the gateway programs through their standard inputs. Gateway programs typically return data through standard output.

“Client device” refers to any device, any automated computing machinery, capable of requesting access to a resource. Examples of client devices are personal computers, internet-enabled special purpose devices, internet-capable personal digital assistants, wireless handheld devices of all kinds, garage door openers, home security computers, thumbprint locks on briefcases, web-enabled devices generally, and handheld devices including telephones, laptop computers, handheld radios, and others that will occur to those of skill in the art. Various embodiments of client devices are capable of asserting requests for access to resources via wired and/or wireless couplings for data communications. The use as a client device of any instrument capable of a request for access to a resource is well within the present invention.

A “communications application” is any data communications software capable of operating couplings for data communications, including email clients, browsers, special purpose data communications systems, as well as any client application capable of accepting data downloads (downloads of security objects or resources, for example) via hardwired communications channels such as, for example, a Universal Serial Bus or ‘USB,’ downloads through wired or wireless networks, and downloads through other means as will occur to those of skill in the art. In typical embodiments of the present invention, communications applications run on client devices.

“DCOM” means ‘Distributed Component Object Model,’ an extension of Microsoft's Component Object Model (“COM”) to support objects distributed across networks. DCOM is part of certain Microsoft operating systems, including Windows NT, and is available for other operating systems. DCOM serves the same purpose as IBM's DSOM protocol, which is a popular implementation of CORBA. Unlike CORBA, which runs on many operating systems, DCOM is currently implemented only for Windows.

“Group” refers to a group of users for whom access to a resource is controlled through a group security object.

“GSO” abbreviates group security object.

“GSCO” abbreviates group security control object.

“HTML” stands for ‘HyperText Markup Language,’ a standard markup language for displaying web pages on browsers.

“HTTP” stands for ‘HyperText Transport Protocol,’ the standard data communications protocol of the World Wide Web.

A “hyperlink,” also referred to as “link” or “web link,” is a reference to a resource name or network address which when invoked allows the named resource or network address to be accessed. More particularly in terms of the present invention, invoking a hyperlink implements a request for access to a resource. Often a hyperlink identifies a network address at which is stored a resource such as a web page or other document. As used here, “hyperlink” is a broader term than “HTML anchor element.” Hyperlinks include links effected through anchors as well as URIs invoked through ‘back’ buttons on browsers, which do not involve anchors. Hyperlinks include URIs typed into address fields on browsers and invoked by a ‘Go’ button, also not involving anchors. In addition, although there is a natural tendency to think of hyperlinks as retrieving web pages, their use is broader than that. In fact, hyperlinks access “resources” generally available through hyperlinks including not only web pages but many other kinds of data and server-side script output, servlet output, CGI output, and so on.

“ID” abbreviates “identification,” depending upon context, usually meaning ‘identification code’ or ‘identification field.’ It is a style of reference in this disclosure to refer to user identification codes as “user IDs.” By convention in this disclosure, the field name “UserID” or a variant is used to store a user ID.

“LAN” means local area network.

“Network” is used in this specification to mean any networked coupling for data communications among computers or computer systems. Examples of networks useful with the invention include intranets, extranets, internets, local area networks, wide area networks, and other network arrangements as will occur to those of skill in the art.

An “ORB” is a CORBA Object Request Broker.

“Resource” means any information or physical item access to which is controlled by a group security object of the present invention. Resources often comprise information in a form capable of being identified by a URI or URL. In fact, the ‘R’ in ‘URI’ is ‘Resource.’ The most common kind of resource is a file, but resources include dynamically-generated query results, the output of CGI scripts, dynamic server pages, documents available in several languages, as well as physical objects such as garage doors, briefcases, and so on. It may sometimes be useful to think of a resource as similar to a file, but more general in nature. Files as resources include web pages, graphic image files, video clip files, audio clip files, and so on. As a practical matter, most HTTP resources are currently either files or server-side script output. Server side script output includes output from CGI programs, Java servlets, Active Server Pages, Java Server Pages, and so on.

“RMI,” or “Java RMI,” means ‘Remote Method Invocation,’ referring to a set of protocols that enable Java objects to communicate remotely with other Java objects. RMI's structure and operation is somewhat like CORBA's, with stubs and skeletons, and references to remotely located objects. In comparison with other remote invocations protocols such as CORBA and DCOM, however, RMI is relatively simple. RMI, however, works only with Java objects, while CORBA and DCOM are designed to support objects created in any language.

“Server” in this specification refers to a computer or device comprising automated computing machinery on a network that manages resources and requests for access to resources. A “security server” can be any server that manages access to resources by use of group security objects according to the present invention. A “web server,” or “HTTP server,” in particular is a server that communicates with browsers by means of HTTP in order to manage and make available to networked computers documents in markup languages like HTML, digital objects, and other resources.

A “Servlet,” like an applet, is a program designed to be run from another program rather than directly from an operating system. “Servlets” in particular are designed to be run on servers from a conventional Java interface for servlets. Servlets are modules that extend request/response oriented servers, such as Java-enabled web servers. Java servlets are an alternative to CGI programs. The biggest difference between the two is that a Java servlet is persistent. Once a servlet is started, it stays in memory and can fulfill multiple requests. In contrast, a CGI program disappears after it has executed once, fulfilling only a single a request for each load and run. The persistence of Java servlets makes them generally faster than CGI because no time is spent on loading servlets for invocations after a first one.

A “URI” or “Universal Resource Identifier” is an identifier of a named object in any namespace accessible through a network. URIs are functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where a resource, particularly a web page, a CGI script, or a servlet, is located on a network, usually the Internet. URIs directed to particular resources, such as particular HTML files or servlets, typically include a path name or file name locating and identifying a particular resource in a file system coupled through a server to a network. To the extent that a particular resource, such as a CGI file or a servlet, is executable, for example to store or retrieve data, a URI often includes query parameters, or data to be stored, in the form of data encoded into the URI. Such parameters or data to be stored are referred to as ‘URI encoded data.’

“URLs” or “Universal Resource Locators” comprise a kind of subset of URIs, wherein each URL resolves to a network address. That is, URIs and URLs are distinguished in that URIs identify named objects in namespaces, where the names may or may not resolve to addresses, while URLs do resolve to addresses. Although standards today are written on the basis of URIs, it is still common to such see web-related identifiers, of the kind used to associate web data locations with network addresses for data communications, referred to as “URLs.” This specification refers to such identifiers generally as URIs.

“User” refers to a computer user, a member of a group, for whom access to a resource is controlled through a group security object.

“WAN” means ‘wide area network.’ One example of a WAN is the Internet.

“World Wide Web,” or more simply “the web,” refers to a system of internet protocol (“IP”) servers that support specially formatted documents, documents formatted in markup languages such as HTML, XML (extensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP or WAP (the ‘Wireless Access Protocol’), in support of URIs and documents in markup languages, regardless of whether such servers or groups of servers are coupled to the World Wide Web as such.

### Detailed Description

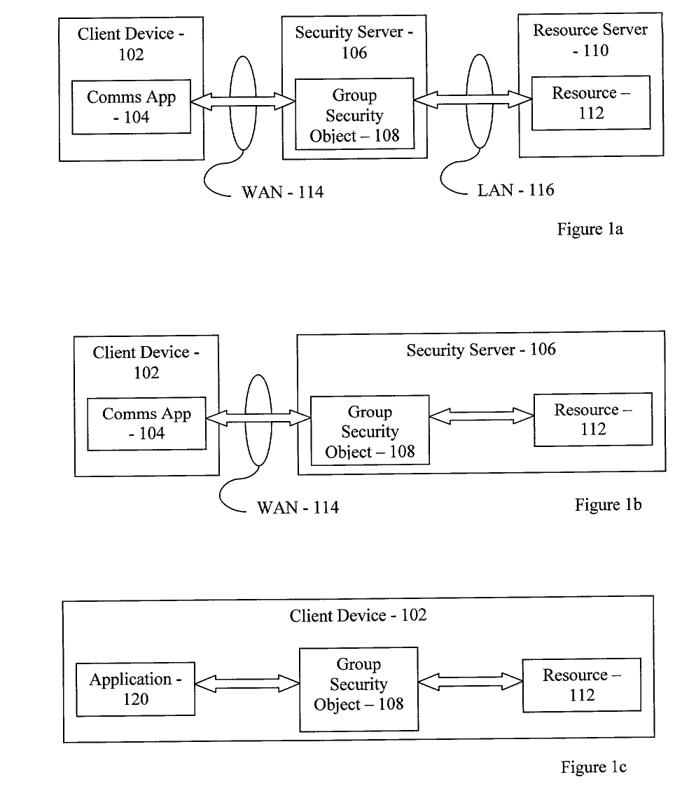

Embodiments of the present invention provide group security objects for improving the administration of controlling access to secured resources. FIGS. 1a, 1b, and 1c set forth block diagrams depicting alternative exemplary data processing architectures useful in various embodiments of the present invention.

As illustrated in FIG. 1a, some embodiments of the present invention deploy group security objects (108) in security servers (106) coupled for data communications through LANs (116) to resource servers (110) upon which resources (112) are stored. Such embodiments typically are coupled for data communications to client devices (102) through networks such as WANs (114) or LANs (116). Data communications between client devices and security servers in such architectures are typically administered by communications applications (104), including, for example, browsers. WANs include internets and in particular the World Wide Web. Client devices (102) as defined above include any automated computing machinery capable of accepting user inputs through a user interface and carrying out data communications with a security server. A “security server” is any server that manages access to resources by use of security objects according to the present invention.

As illustrated in FIG. 1b, some embodiments of the present invention deploy group security objects (108) in security servers (106) upon which are stored secured resources (112). The architecture of FIG. 1b illustrates that resources can be stored on the same server that secures access to the resources. In all this discussion, the term ‘security server’ refers to a server that manages access to resources by use of group security objects according to the present invention. There is no limitation that a ‘security server’ as the term is used in this disclosure must provide other security services, or indeed that a security server must provide any security services whatsoever, other than managing access to resources through group security objects. FIGS. 1a and 1b show group security objects deployed in or upon security servers, but having group security objects deployed upon it is not a requirement for a server to be considered a security server within the usage of this disclosure. Group security objects may be deployed anywhere on a network or on client devices. If a server manages access to resources by use of group security objects, regardless where the security objects are located, then that server is considered a ‘security server’ in the terminology of this disclosure. Some ‘security servers’ of the present invention, as described in more detail below, are ordinary web servers modified somewhat to support lookups in access control tables. Many ‘security servers’ of the present invention, however, are ordinary unmodified web servers or Java web servers, designated as ‘security servers’ only because they manage access to resources by use of group security objects, group security objects which may or may not be installed upon those same servers.

As shown in FIG. 1c, some embodiments deploy group security objects (108) in client devices (102) which themselves also contain both the applications software (120) concerned with accessing the resources and also the resources (112) themselves. This architecture includes devices in which a group security object may be created on a more powerful machine and then downloaded to a less powerful machine. The less powerful machine then often is associated one-to-one with a single resource, or is used to secure a relatively small number of resources. One example of this kind of embodiment includes a garage door opener in which a security application program (120) is implemented as an assembly language program on a tiny microprocessor or microcontroller and the secured resource is a motor that operates a garage door. Another example is a briefcase fitted with a microprocessor or microcontroller, a fingerprint reader, and a USB port through which is downloaded a group security object that controls access to a resource, an electromechanical lock on the briefcase.

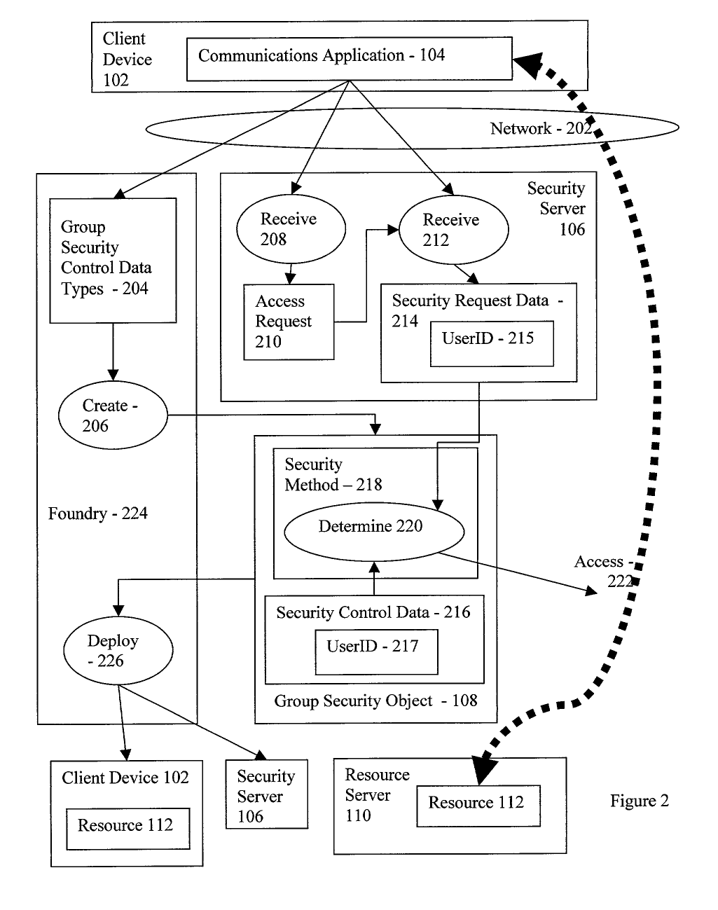

FIG. 2 sets forth a data flow diagram depicting an exemplary method of controlling access to a resource (112). The method of FIG. 2 includes creating (206) a group security object (108) in dependence upon user-selected group security control data types (204), the group security object comprising security control data (216). In typical embodiments of the present invention, the security control data (216) includes at least one security control user identification (217). As described in more detail below, security control user identifications, or “userIDs,” are used to define group membership and to determine whether to grant access to a resource.

In this disclosure, application software programs that administer the creation of group security objects are called ‘foundries.’ In typical embodiments according to FIG. 2, a foundry (224) prompts a user through a user interface displayed on a client device (102) to select one or more security control data types through, for example, use of a menu similar to this one:

Please select a security control data type:

1. User Logon ID

2. Password

3. Fingerprint

4. Voice Recognition

5. Retinal Scan

Your selection (1-5):______

A foundry (224) creates (206) a group security object (108) in dependence upon users' selections of security control data types in the sense that the foundry aggregates, or associates by reference, with the group security object, group security control data types (204) according to the user's selection. If, for example, the user selects menu item 1 for a user logon ID, the foundry causes a group security control data type to be included in the group security object for administration of a user logon ID. If the user selects menu item 2 for a password, the foundry causes a group security control data type to be included in the group security object for administration of passwords. If the user selects menu item 3 for a fingerprint, the foundry causes a group security control data type to be included in the group security object for administration of fingerprints. And so on for voice recognition technology, retinal scans, and any other kind of security control data amenable to administration by electronic digital computers.

As described in more detail below, group security control data types are implemented typically as group security control classes. Foundries typically operate by passing a data type code to a parameterized factory method in a factory class that in turn instantiates a corresponding group security control object. It is the constructors of the group security control objects themselves that typically prompt for required security control data (216) including a security control user identification (217), all of which is set in motion through user interaction with a user interface presented by a foundry. This is the sense in which a foundry “causes” inclusion of group security control data types in group security objects.

In typical embodiments of the present invention, as shown in FIG. 2, a group security object (108) includes at least one security method (218). In this disclosure, ‘security method’ means an object oriented member method. The security method typically is a software routine called for validating or determining whether to grant access to a resource and what level of authorization to grant. As discussed in more detail below, the security method can have various names depending on how the group security object is implemented, ‘main( )’ for group security objects to be invoked with Java commands, ‘security( )’ for servlets, and so on. These exemplary names are for clarity of explanation only, not for limitation. In many forms of group security object, the name chosen for a security method is of no concern whatsoever.

Embodiments according to FIG. 2 include receiving (208) a request (210) for access to the resource and receiving a request for access to a resource can be implemented as a call to a security method in a group security object. A group security object implemented in Java, for example, can have a main( ) method called by invocation of the group security object itself, as in calling ‘java MySecurityObject,’ resulting in a call to MySecurityObject.main( ). This call to main( ) is in many embodiments itself receipt of a request for access to the resource secured by use of the group security object.

The method of FIG. 2 includes receiving (212) security request data (214). Security request data (214) includes at least one security request user identification (215). Continuing with the example of a group security object called ‘MySecurityObject,’ the group security object's member security method can prompt the user, or cause the user to be prompted, for security request data in dependence upon the security control data types in use in the group security object. That is, if the group security object contains security control data of type ‘User Logon ID,’ then the security method causes the user to be prompted to enter security request data, expecting the security request data received to be a user logon ID. If the group security object contains security control data of type ‘Password,’ then the security method causes the user to be prompted to enter security request data, expecting the security request data received to be a password. If the group security object contains security control data of type ‘Fingerprint,’ then the security method causes the user to be prompted to enter security request data, expecting the security request data received to be a digital representation of a fingerprint. The security method in such embodiments typically does not include in its prompt to the user any identification of the security control data type expected. This is, after all, a security system. If the user does not know that the user must provide in response to a first prompt a password and in response to a second prompt a thumbprint in order to gain access to a particular resource, then the user probably, and advantageously, ought not gain access to the resource.

As described in more detail below, group security objects typically associate by reference one or more group security control objects having member methods that carry out actual security request data validation. Calls from a group security object's security method to member methods in group security control objects are what is meant by saying that a security method “causes” a user to be prompted for security request data. Security request user IDs (215) are matched with security control user IDs (217) in group security control objects to determine whether to grant access to user controls, also described in much more detail below.

The method of FIG. 2 includes determining (220) access (222) to the resource in dependence upon the security control data (216) and the security request data (214). More particularly, determining access means determining whether to grant access and what kind of access is to be granted. Generally in this disclosure, whether to grant access to a particular user or a particular group of users is referred to as ‘authentication,’ and the kind of access granted is referred to as ‘authorization level.’ Determining whether to grant access typically includes determining whether security access data provided by a user in connection with a request for access to a resource matches corresponding security control data. That is, in the example of a password, determining whether to grant access includes determining whether a password provided as security access data matches a password stored in aggregation with a group security object as security control data. In the example of a thumbprint, determining whether to grant access includes determining whether a thumbprint provided as security access data matches a thumbprint stored in aggregation with a group security object as security control data. And so on. Authorization levels include authorization to read a resource, authorization to write to a resource (which typically includes ‘edit’ authority and ‘delete’ authority), and authorization to execute a resource (for which one ordinarily needs an executable resource).

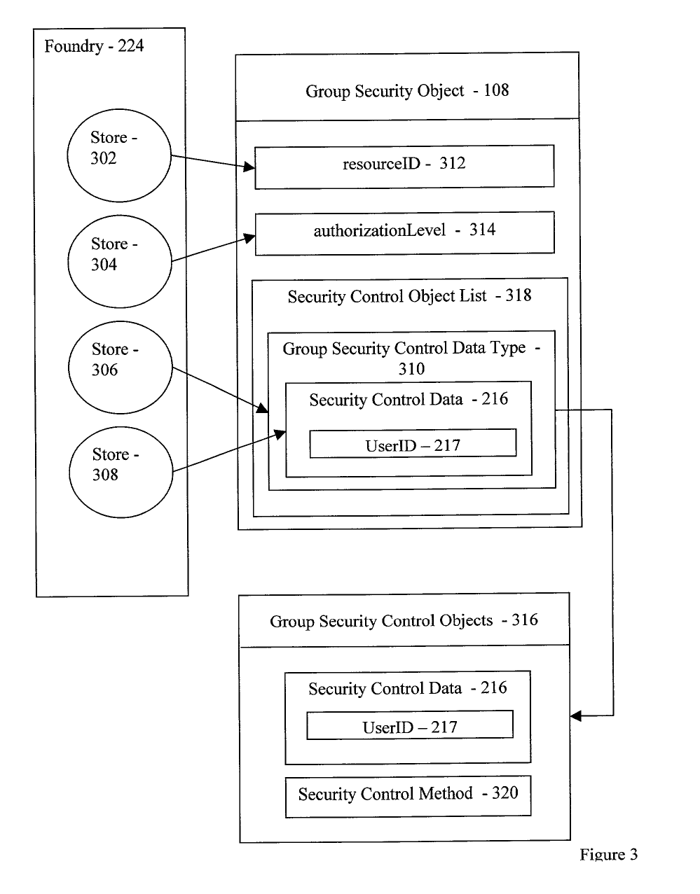

FIG. 3 sets forth a data flow diagram depicting an exemplary method of creating a group security object. In other words, the method depicted in FIG. 3 drills down on what it means to create a group security object in a foundry of the present invention. In the method of FIG. 3 creating a group security object is shown to include storing (302) in the group security object (108) a resource identification (312) for the resource. In other words, the foundry prompts the user to enter a filename, pathname, URL, URI, or any useful means as will occur to those of skill in the art for identifying a resource to be secured by the group security object. In this example, the foundry then stores (302) the identification of the resource in a member field called ‘resourceID’ (312) in the group security object itself.

In the method of FIG. 3 creating a group security object includes storing (304) in the group security object (108) an authorization level (314) of access for the resource. In other words, the foundry prompts the user to enter an authorization level, ‘read,’ ‘write,’ or ‘execute,’ for example, and then stores (304) the authorization level in a member field named ‘authorizationLevel’ (314) in the group security object itself.

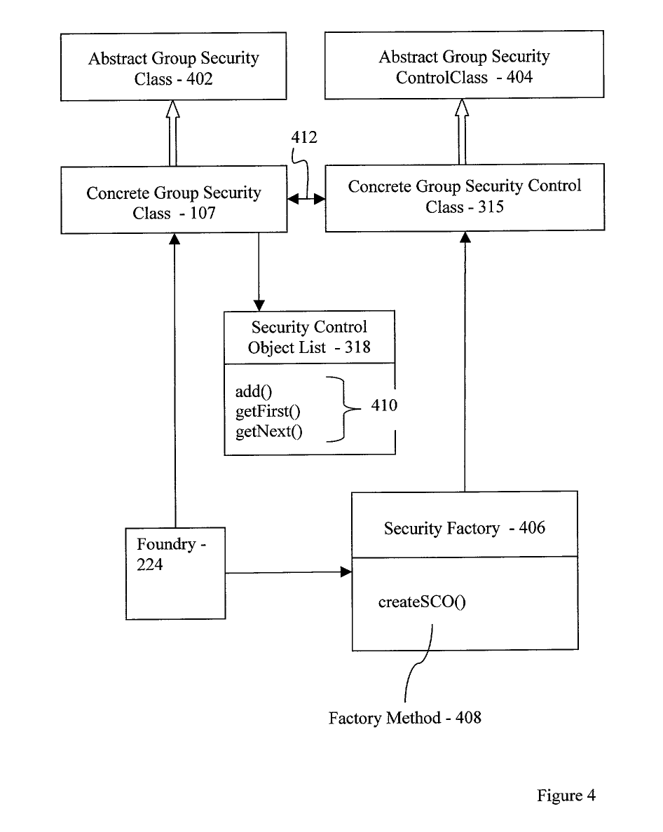

In the method of FIG. 3, creating a group security object includes storing (306) in the group security object (108) user-selected security control data types (310). More particularly, in the method of FIG. 3, security control data types (310) are stored as references to group security control objects (316). Security control data types (310) in fact are typically implemented as group security control classes (404 on FIG. 4) from which group security control objects are instantiated. Storing (306) user-selected security control data types comprises storing references to group security control objects (316) in a security control object list (318) in the group security object (108), including instantiating a group security control object (316) of a group security control class in dependence upon security control data type. That is, if the security control data type is a password, then the foundry causes to be instantiated from a password group security control class a password group security control object, storing in the security control object list (318) a reference to the password group security control object. Similarly, if the security control data type is a fingerprint, then the foundry causes to be instantiated from a fingerprint group security control class a fingerprint group security control object, storing in the security control object list (318) a reference to the fingerprint group security control object. And so on.

The security control object list (318) itself is typically implemented as a container object from a standard library in, for example, C++ or Java. That is, the security control object list (318) is typically a class object aggregated by reference to the group security object (108).

In the method of FIG. 3, creating a group security object includes storing (308) in the group security object security control data (216) for each user-selected security control data type (310). Instantiating a group security control object (316) calls a constructor for the group security control object. In some embodiments, it is the constructor that prompts for security control data of the type associated with the group security control object. That is, if the security control data object is a password group security control object, its constructor prompts for a password to be stored (308) as security control data (216). Similarly, if the security control data object is a thumbprint group security control object, its constructor prompts for a thumbprint to be stored (308) as security control data (216). And so on.

In the method of FIG. 3, storing (308) group security object security control data (216) includes storing a security control user ID (217) in the group security object.

More particularly, group security control data types (310) are typically implemented with references to group security control objects (316), and storing security control user IDs (217) is often carried out by storing security control user IDs in group security control objects (316). The constructor for a group security control object also typically prompts for a security control user ID (217) for the group security control object.

In architectures similar to those illustrated in FIG. 1a and 1b in which a client device (102) is located remotely across a network (114) from a security server (106) upon which security control data is to be stored (308), the security control data advantageously is communicated across the network from the client device to the security server in encrypted form. One example of such encrypted communications is network messaging by use of ‘SSL,’ that is, communications connections through a ‘secure Sockets Layer,’ a known security protocol for use in internet protocol (“IP”) networks, in which encryption of message packets is provided as a standard communications service. In addition to encrypted communications of security control data, at least some elements of security control data, such as, for example, passwords, also are advantageously stored (308) in encrypted form.

Having presented an overview of security object creation, now is presented a more detailed explanation of foundry operation by use of the pseudocode depiction of an exemplary foundry:

Class Foundry {

private String selectionText =

“Please select a security control data type:

1. Password
2. Fingerprint
3. Voice Recognition

Your selection (1-3): _{——}”

void main( ) {

// create group security object
GroupSecurityClass GSO = new GroupSecurityClass( );
// identify resource secured by the new group security object
Resource resourceID =

getResourceID(“Please enter resource ID: _{——}”);

// store resource ID in group security object
GSO.setResource(resourceID);
// prompt for authorization level
char authorizationLevel =

getAuthorizationLevel(“Please enter authorization
level: _{——}”);

// store authorization level in group security object
GSO.setAuthorizationLevel(authorizationLevel);
// get a first ‘SCD-Type,’ Security Control Data Type
SCD-Type = getUserSelection(selectionText);
while(SCD-Type != null) {

// based on SCD-Type, create Group security control object
// pass reference to GSO, for GSCO constructor and
// bidirectional navigation between GSO and GSCO
GSCO = GSCO-Factory.createGSCO(GSO, SCD-Type);
// add new GSCO to the list in the Group security object
GSO.add(GSCO);
// get another SCD-Type, as many as users want
SCD-Type = getUserSelection(selectionText);

} // end while( )

} // end main( )

} // end Foundry

With reference to FIGS. 2 and 3, the pseudocode foundry creates (206) a group security object (108) by instantiating a group security class:

GroupSecurityClass GSO new GroupSecurityclass().

The pseudocode foundry then stores (302) a resource identification (312) through:

Resource resourceID=getResourceID(“Please enter resource ID:___ ”);

GSO.setResource(resourceID);

The call to GSO.setResource( ) is a call to a member method in the group security object that stores in the group security object a reference or location for the resource secured by the group security object. The pseudocode foundry stores (304) an authorization level (314) through:

char authorizationLevel=getAuthorizationLevel(“Please enter authorization level:___”);

GSO.setAuthorizationLevel(authorizationLevel);

The call to GSO.setAuthoriztionLevel( ) is a call to another member method in the group security object.

The pseudocode foundry stores (306) security control data types (310) by repeated calls to GSO.add(GSCO). GSO.add( ) is a member method in the group security object that adds group security control objects to a list in the group security object.

The pseudocode foundry stores (308) security control data (216) in the group security object (108) by repeated calls to the factory method GSCO-Factory.createGSCO( ). One group security control object is instantiated for each such call, resulting in a call to a group security control object constructor for each such call, and it is the constructor in each case that prompts for and stores a type of security data with which the group security control object is associated, fingerprints for fingerprint group security control object, passwords for password group security control objects, and so on. A separate group security control object is created, through calls to the factory method, for each security control data type selected or request by the user in response to getUserSelection(selectionText).

Each time the user selects a new group security control data type, the foundry creates a new group security control object by calling a factory method in a group security control object factory. The group security control object factory, in this example, is a class called GSCO-Factory, and the factory method is GSCO-Factory.createGSCO( ). The calls to GSCO.setSecurityControlData( ) are polymorphic calls, each of which typically accesses a different group security control object although exactly the same line of code is used for each such call. In this elegant solution, the foundry itself never knows or cares which security control data types are implemented or what security control data is stored in group security objects it creates.

The process of creating group security control objects can be carried out as illustrated in the following pseudocode factory class:

//
// Group security control object Factory Class
//
// Defines a parameterized factory method for creating group security
control objects
//
class GSCO-Factory {

public static SecurityControlClass createGSCO(SCD-Type) {

// initial null reference to new Group security control object
SecurityControlClass SecurityControlObject = null;
switch(GSO, SCD-Type) {

case LOGONID:

SecurityControlObject =

new LogonIDSecurityControlClass(GSO); break;

case PASSWORD:

SecurityControlObject =

new PasswordSecurityControlClass(GSO); break;

| | |
|---|---|
| ... ... ... | // Can have many security control data types, |

// not merely these four

case FINGERPRINT:

SecurityControlObject =

new FingerprintSecurityControlClass(GSO);
break;

case RETINA:

SecurityControlObject =

new RetinaSecurityControlClass(GSO); break;

} // end switch( )
return SecurityControlObject;

} // end createGSCO ( )

} // end class GSCO-Factory

The factory class implements the createGSCO( ) method, which is a so-called ‘parameterized’ factory method. CreateGSCO( ) accepts two parameters, a reference ‘GSO’ to the group security object with which the current group security control object is associated by reference and the security control data type ‘S CD-Type’ of the security control data to be administered by a group security control object. CreateGSCO( ) operates a switch( ) statement in dependence upon SCD-Type to decide exactly which group security control class to instantiate depending on which type of security control data is needed—logon IDs, passwords, fingerprint, voice identifications, and so on.

Each ‘new’ call in the switch( ) statement calls a constructor defined to accept as a parameter a reference to a group security object ‘GSO,’ which is needed for bi-directional communication or navigation between the group security control object and its associated group security object. That is, without making the ‘GSO’ reference available to the group security control objects, they would be unable to call member methods in their associated group security objects. Although only four security control data types are illustrated in the factory class (logon IDs, passwords, fingerprints, and retinal scans), in fact the factory can create and return to the calling foundry a group security control object for any type of security control data supported by the security system in which it is installed, any type of group security control object for which a security control data type or class (404) is defined.

Group security control objects can be instantiated from a group security control class defined according to the following exemplary pseudocode:

//
// abstract GroupSecurityControlClass - Example Number One
//
Abstract Class SecurityControlClassOne {

String MyUserID; // security control user ID
String GSOuserID; // userID currently set in MyGSO
GroupSecurityClass MyGSO; // reference to associated group security
object private String SecurityControlData;
// constructor
SecurityControlClassOne(GSO) {

MyGSO = GSO;
MyUserID = prompt(“Please enter user ID: _{————}”);
SecurityControlData =

prompt(“Please enter security control data: _{——});

}
public boolean validate( ) {

GSOuserID = MyGSO.getUserID( );
// MyGSO.userID does not match, so get new one ...
If (GSOuserID != MyUserID) {

GSOuserID = prompt(“Please enter user ID: _{——}”);
GSO.setUserID(GSOUserID);

}
// if it still does not match, kill validation
if(GSOuserID != MyUserID {

return false;

}
// now there is a match for userID, so validate ...
else {

// prompt for security request data
// test it against security control data
// if okay, return true, else return false.

}

} // end validate( )

} // end GroupSecurityControlClassOne

The pseudocode group security control class depicts an object oriented ‘interface.’ In Java, such structures are literally known as ‘interfaces’ to be ‘extended’ by concrete classes. In C++, such structures are known as abstract base classes from which concrete subclasses inherit. Either way, the pseudocode group security control class establishes a set of public member methods to be used by all group security control objects.

The public member methods can, and usually will, be advantageously overridden in definitions of concrete subclasses. The validate( ) function in particular will be overridden according to the kind of security control data and security request data that must be compared. Text passwords, for example, require different comparison procedures than are required by bitwise comparisons of retinal scans. The pseudocode group security control class provides an example of string storage for security control data, which may work all right for logon IDs and passwords, but will not work for fingerprints and voice recognition.

The member fields and member methods of the pseudocode group security control class form an interface that is fully expected to be overridden in subclasses from which group security control objects are instantiated, although all subclasses are required to implement in some fashion the public member fields and public member methods of the abstract base class, the group security control class. Here, beginning with a concrete group security control class for passwords, are several examples of concrete group security control classes from which practical group security control objects are instantiated by the factory method SecurityControlClass.createGSCO( ).

//
// concrete group security control class for passwords
//
Class PasswordSecurityControlClass : GroupSecurityControlClassOne {

String MyUserID; // security control user ID
String GSOuserID; // userID currently set in MyGSO
GroupSecurityClass MyGSO; // reference to associated group
security object
// now security control data is in fact the password
private String SecCtlPassword;
// constructor
SecurityControlClass(GSO) {

MyGSO = GSO;
// reminder: this is a group security control object
// must have userID
MyUserID = prompt(“Please enter user ID: _{————}”);
// now get security control data
SecCtlPassword = prompt(“Please enter password: _{————});

}
public boolean validate( ) {

GSOuserID = MyGSO.getUserID( );
// MyGSO.userID does not match, so get new one ...
If (GSOuserID != MyUserID) {

GSOuserID = prompt(“Please enter user ID: _{——}”);
GSO.setUserID(GSOUserID);

}
// if it still does not match, kill validation
if(GSOuserID != MyUserID {

return false;

}
// now there is a match for userID, so validate ...
else {

// prompt for security request data
SecReqPassword = prompt(“Please enter password:
_{————});
// test security request data against security control data
if(SecCtlPassword == SecReqPassword)

return true;

else return false;

}

} // end validate( )

} // end PasswordSecurityControlClass

PasswordSecurityControlClass is similar to its parent GroupSecurityControlClass, but it is useful to note that PasswordSecurityControlClass, unlike its abstract parent, defines a class that can actually be instantiated as a group security control object for determining access to resources on the basis of entry of a valid password. It is acceptable within the scope of the invention to define concretely a parent group control class so that it handles a particular kind of security control data, such as, for example, string data, and then instantiate group security control objects directly from such a base class as well as through inheriting subclasses. On balance, however, although it is not a limitation of the invention, it is generally considered somewhat more flexible to utilize a base class to declare an interface and instantiate actual group security control objects from concrete derived subclasses. The following pseudocode group security control class for fingerprints illustrates in more detail how group security control classes differ across security control data types.

//
// concrete group security control class for fingerprints
//
Class FingerprintSecurityControlClass : GroupSecurityControlClassOne {

String MyUserID; // security control user ID
String GSOuserID; // userID currently set in MyGSO
GroupSecurityClass MyGSO; // reference to associated group security
object
private FILE SecurityControlData;
// constructor
SecurityControlClass(GSO) {

MyGSO = GSO;
MyUserID = prompt(“Please enter user ID: _{————}”);
SecurityControlData =

prompt(”Please enter security control data: _{——});

}
public boolean validate( ) {

GSOuserID = MyGSO.getUserID( );
// MyGSO.userID does not match, so get new one ...
If (GSOuserID != MyUserID) {

GSOuserID = prompt(“Please enter user ID: _{——}”);
GSO.setUserID(GSOUserID);

}
// if it still does not match, kill validation
if(GSOuserID != MyUserID {

return false;

}
// now there is a match for userID, so validate ...
else {

// prompt for fingerprint, received as a file fingerprint scan
FILE SecurityRequestData =

prompt(“Enter Security Request Data:
_{————}”);

if((bitwiseCompare(SecurityControlData,

SecurityRequestData)) != true)

return true;

else return false;

}

} // end validate( )

} // end FingerprintSecurityControlClass

In FingerprintSecurityControlClass, SecurityControlData is in a file rather than a string. More particularly, it is typically in a graphic image file such as a bitmap or JPEG. The prompt( ) function in the validate( ) method therefore expects the user to provide a fingerprint file in response to the prompt for security control data. In addition, the bitwiseCompare( ) method, although not shown separately in detail, nevertheless typically is implemented to open both files (SecurityControlData and SecurityRequestData), compare them bit by bit, and, through validate( ), deny access to a resource if the comparison fails.

Group security objects themselves can be implemented, for example, according to the following pseudocode for a group security class.

//
// GroupSecurityClass - Example Number One
// a class from which group security objects are instantiated
//
Class GroupSecurityClassOne
{

// make userID storage available at the GSO level
// to help minimize prompts from GSCOs
private String UserID;
public void setUserID(GSCOuserID) {UserID = GSCOuserID;}
public String getUserID( ) {return(UserID);}
private Resource aResourceID;
public void setResource(resourceID) {aResourceID = resourceID;}
char anAuthorizationLevel;
public void setAuthorizationLevel(authorizationLevel) {

anAuthorizationLevel = authorizationLevel;

}
// list of group security control objects
private List aList = new List( );
public void add(GSCO) {aList.add(GSCO);}
// validate requests for access against all GSCOs in the List
public boolean main( )
{

GSCO = aList.getFirst( );
while(GSCO != null)
{

if((GSCO.validate( )) != true) {

denyAccess( );
return false;

}
GSCO = aList.getNext( );

}
// all GSCOs in the List are now validated
grantAccess(anAuthorizationLevel);
return true;

} // end validate( )

} // end GroupSecurityClassOne

GroupSecurityClassOne provides a storage location for a resource identification (312) named ‘resource ID,’ as well a member method named ‘setResourceID( )’ for storing (302) the resource identification. Similarly, the group security class provides a field called ‘anAuthorizationLevel’ for storing authorization level (314) and a method called ‘setAuthorizationLevel( )’ for storing (304) authorization level. The exemplary pseudocode group security class GroupSecurityClassOne provides storage in the form of a list called ‘aList’ for storing group security control objects. In C++, for example, it would be possible to store group security control objects as such, but in most embodiments, the list is used advantageously to store group security control objects as references.

The group security class GroupSecurityClassOne includes a method, addGSCO( ) for adding a group security control object to the list. The methods aList.add( ), aList.getFirst( ), and aList.getNext( ) are member methods in a list object that effectively operate a list object as an iterator. An ‘iterator’ is a conventional object oriented design pattern that supports sequential calls to elements of an aggregate object without exposing underlying representation. In this example, main() assumes that aList.getNext( ) returns null upon reaching the end of the list. It is common also, for example, for list classes to support a separate member method called, for example, ‘isDone( ),’ to indicate the end of a list. Any indication of the end of a list as will occur to those of skill in the art is well within the scope of the present invention.

In addition, the exemplary pseudocode group security class GroupSecurityClassOne includes a member method, ‘main( ),’ that validates security access data in turn for each group security control object in the list. In this particular example, the validation method is called ‘main( )’ in support of implementing group security objects in Java, so that the validation method can be called by a call to the object name itself. On the other hand, when GroupSecurityClass is implemented as a Java servlet, there is no requirement for a member method named ‘main( ),’ because, although servlets also are invoked by use of the class name itself, the interior interface requirements for servlets are different. When GroupSecurityClass is implemented as a Java servlet, therefore, the name of the member method ‘main( )’ is changed to implement a member method signature from the standard Java servlet interface, such as, for example: public void service(ServletRequest req, ServletResponse res).

The validation method main( ) operates by obtaining from the list each group security control object in turn and calling in each group security control object the interface member method ‘validate( ).’ As described in detail above, the validate() method in each group security control object prompts for security access data, compares security access data to security control data, and returns true or false according to whether the comparison succeeds or fails. GroupSecurityClassOne.main( ) operates by denying access and returning false if validation fails for any group security control object in the list. GroupSecurityClass.main( ) grants access and returns true if validation succeeds for all group security control objects in the list.

If GroupSecurityClassOne.main( ) grants access, the access granted has the authorization level set by the member method setAuthorizationLevel( ). More particularly, in the method of FIG. 2, determining (220) access (222) includes authorizing a level of access in dependence upon the authorization level of access for the resource (314 on FIG. 3). In the example of group security objects implemented to accept calls from hyperlinks in web pages displayed in browsers on client devices located remotely across a network, the group security objects themselves are implemented often as servlets or CGI programs that administer HTTP GET and PUT request messages. In such exemplary embodiments, a group security object granting access to a resource having only ‘read’ authorization level would honor a GET request by transmitting to the client browser a copy of the resource in HTML. The same exemplary group security object, however, would not honor a PUT request for writing data to the resource.

FIG. 4 sets forth a class relations diagram summarizing exemplary relations among classes and objects useful in various embodiments of the present invention. As shown in the example of FIG. 4, useful in many embodiments, concrete group security classes (107), from which group security objects are instantiated, are subclasses that inherit from abstract group security classes (402). Similarly, concrete group security control classes (315), from which group security control objects are instantiated, are subclasses that inherit from abstract group security control classes (404).

In addition, it is useful to remember that ‘abstract,’ as the term is used here to describe classes, is used in support of interface definition, in a fashion similar to its use in the terminology of C++. In Java, structures that here are called abstract classes would be called ‘interfaces,’ as such. No doubt such structures have other names in other environments, but here they are called ‘abstract classes’ and used to illustrate declarations of object oriented interfaces.

Foundries (224) are shown in FIG. 4 as classes having references to factory classes (406) and concrete group security classes (107). Foundries (224), as described in detail above, cooperate with factories (406) and group security objects instantiated from concrete group security classes (315) by passing to security objects references to group security control objects for inclusion in security control object lists (318). The arrow (412) between group security classes (107) and group security control classes (315) indicates that a group security class ‘has a’ group security control class, because the reference needed to implement the object oriented ‘has a’ relationship is provided to the group security class by a foundry (224) for storage in a security control object list (318). The arrow (412) drawn with two arrowheads indicates the availability of bi-directional communications or navigation between group security objects and group security control objects, as described above in this disclosure.

Security control object lists (318) are often implemented as container objects from a standard library in, for example, C++ or Java. That is, a security control object list (318) is typically a class object aggregated by reference to a group security object instantiated from a group security class (107). With member methods (410) such as add( ), getFirst( ), and getNext( ), a security control object list (318) often can function as a so called ‘iterator,’ greatly easing manipulation of temporal security control objects on behalf of a security object. Iterator operations are illustrated in the pseudocode above for SecurityClass.

GroupSecurityClassOne implements a method according to FIGS. 2 and 3 in which security control data (216) can comprise more than one security control user ID (217). In such embodiments, to the extent that security control data includes more than one security control user ID, receiving (208) security request data comprises receiving more than one security request user ID (215), and determining access (220) to the resource includes validating security request data for all user-selected data types.

That is, described in terms of the pseudocode examples of group security control classes described above, and in particular with respect to the validate( ) functions in them, each group security control class, or objects instantiated from them, validates by comparing security control data and security request data every time their validate( ) functions are invoked. As discussed in more detail below, this is not always the case, and the effect of it in such embodiments is that each and every group security control object associated with a group security object through a list of references to them must successfully validate its security request data with respect to its security control data in order for any access to be granted to a resource secured by an associated group security control object.

It is useful to note that group membership for any particular user, according to such embodiments, means that at least one group security control object contains that user's user ID in its security control data. That is the entirety of group membership. There are no group definition records, no access control tables with group identification columns, and no other group-related security structures or controls at the application level. A user is a member of a group whose access to a resource is controlled through a group security object if that user's user ID is stored as a security control data element in any group security control object associated by reference with the group security object, a lean and elegant result of embodiments of the present invention.

By way of further explanation, consider a group of users creating and using a group security object of the kind illustrated by GroupSecurityClassOne and associating group security control objects of the kind illustrated by GroupSecurityControlClassOne. Assume there are two users in the group, although in fact the group can comprise any number of users. The users access a foundry of the kind described above through a terminal having a fingerprint scanner and create four group security control objects, two for each user, having security control data comprising passwords for each user and thumbprints for each user. From the validate( ) functions in the group security control objects and the function of main( ) in the group security object so created, it is clear that in order for either user to gain access to the resource protected by the group security object so created, both users must access the group security control object and successfully provide their passwords and fingerprints, in correct sequence, in order to obtain any access to a secured resource.

The same would be true for a group having three users or eight users or twelve users. All users of a group security object like the one illustrated in GroupSecurityClassOne associating group security control objects like the one illustrated in GroupSecurityControlClassOne must clear security for access at the same time, all together, or no access. In effect, this kind of embodiment implements a concurrent, multi-user group security control, which is a fine methodology for access control for certain kinds of resources, joint bank accounts, confidential joint project files, and so on.

It is often the case, however, that group membership means that any member of a group can access a resource, subject to security controls, rather than requiring all member to access at the same time. Embodiments supporting access by individual members acting alone can be implemented by use of group security control objects instantiated from group security control subclasses derived from a group security control base class defined, for example, according to the following pseudocode:

//
// abstract GroupSecurityControlClass - Example Number Two
//
Abstract Class SecurityControlClassTwo {

String MyUserID; // security control user ID
String GSOuserID; // userID currently set in MyGSO
GroupSecurityClass MyGSO; // reference to associated group security
object
private String SecurityControlData;
// constructor
SecurityControlClassTwo(GSO) {

MyGSO = GSO;
MyUserID = prompt(“Please enter user ID: _{————}”);
SecurityControlData =

prompt(“Please enter security control data: _{——});

}
public boolean validate( ) {

GSOuserID = MyGSO.getUserID( );
// if GSO does not yet have a userID, get one ...
If (GSOuserID == null) {

GSOuserID = prompt(“Please enter user ID: _{——}”);
GSO.setUserID(GSOUserID);

}
// if GSO has a non-matching userID, return successful
// validation because this group security control object only
// invalidates access in dependence upon its own userID
if(GSOuserID != MyUserID) return true;
// now there is a match for userID, so validate ...
if(GSOuserID == MyUserID) {

// first record the fact of a matching userID
GSO.setUserIDMatch( );
// prompt for security request data
// test it against security control data
// if okay, return true, else return false.

}

} // end validate( )

} // end GroupSecurityControlClassTwo

There are a couple of useful differences between GroupSecurityControlClassOne and GroupSecurityControlClassTwo. GroupSecurityControlClassOne.validate( ) carries out substantive validation comparison every time it is called. One difference the two is that the program logic in GroupSecurityControlClassTwo.validate( ) carries out substantive validations only when a user provides a userID that matches the userlD in the ‘MyUserID’ field in GroupSecurityControlClassTwo's security control data. MyUserID is set when the constructor GroupSecurityControlClassTwo( ) is called at creation time, in our examples, by use of a foundry and a factory method.

In the operation of GroupSecurityControlClassTwo.validate( ), it is possible that some other group security control object from the list in an associated group security object already established a userID in the group security object. So GroupSecurityControlClassTwo.validate( ) checks with “If (GSOuserID==null),” and if there is not yet a userID in the group security object, validate() prompts for one and stores it with a call to GSO.setUserID( ). Storing the current userID in the group security object means that subsequently called group security control object will not need to repeatedly prompt for the userID. Only the first group security control object called needs to prompt for the userID, which it then stores in the group security object for use by all subsequently called group security control objects in the list in the group security object.

The code line “if(GSOuserID!=MyUserID) return true” is important to the function of GroupSecurityControlClassTwo.validate( ) because it means that substantive comparison of security control data and security request data is not carried out when there is no match between the current user's userID and the userID ‘MyUserID’ stored in the security control data of the current group security control object. In other words, the group security control object simply does not care what happens regarding validity with respect to security control data and security request data from any user not identified by MyUserID, and, when faced with such a situation, group security control objects according to GroupSecurityControlClassTwo simply opt out of the validation process by returning true, indicating that validation is just fine with them despite the fact that they have not actually analyzed or compared security control data and security request data.

This somewhat surprising approach works if, in the list of group security control objects in the associated group security object, there is one group security control object whose MyUserID matches the userID of a user seeking access to the resource. That is, it will work because that group security control object will in fact carry out substantive comparison of security control data and security response data, as shown in the pseudocode compound statement following “if(GSOuserID==MyUserID).”

A second difference between GroupSecurityControlClassOne and GroupSecurityControlClassTwo is GroupSecurityControlClassTwo's use of the match setting function GSO.setUserIDMatch( ). SetUerIDMatch( ) is needed because of a technical issue with respect to group security control objects that return true for validation without carryout actual validation. That is, complete mismatches are possible with respect to the userID of a user seeking access to a resource. That is, it is possible that all validate( ) functions in all group security control object in a list in an associated group security object return true, validating access, not because one of them carried out substantive validation and in fact the current user is entitled to access, but because the user provided a userID that matches no MyUserID in any group security control object in the list in the associated group security object. This is a potential problem.

An exemplary answer to the problem is in the first line of pseudocode after “if(GSOuserID==MyUserID)” in GroupSecurityControlClassTwo.validate( ), “GSO.setUserIDMatch( ),” which advises the associated group security object that it found a match between its MyUserID and the current user's asserted userID. Now the main( ) function in the associated group security object needs to be defined so as to detect the match, and that can be done as shown in the following pseudocode example of a group security class:

//
// GroupSecurityClass - Example Number Two
// a class from which group security objects are instantiated
//
Class GroupSecurityClassTwo
{

// detect userID match in group security control object
private boolean UserIDMatch = false;
public void setUserIDMatch( ) {UserIDMatch = true;}
// make userID storage available at the GSO level
// to help minimize prompts from GSCOs
private String UserID;
public void setUserID(GSCOuserID) {UserID = GSCOuserID;}
public String getUserID( ) {return(UserID);}
private Resource aResourceID;
public void setResource(resourceID) {aResourceID = resourceID;}
char anAuthorizationLevel;
public void setAuthorizationLevel(authorizationLevel) {

anAuthorizationLevel = authorizationLevel;

}
// list of group security control objects
private List aList = new List( );
public void add(GSCO) {aList.add(GSCO);}
// validate requests for access against all GSCOs in the List
public boolean main( )
{

UserIDMatch = false; // reset the match indicator
GSCO = aList.getFirst( ); // get the first GSCO from List
while(GSCO != null)
{

if((GSCO.validate( )) != true) {

denyAccess( );
return false;

}
GSCO = aList.getNext( );

}
// all GSCOs in the List are now validated
// and the validation is genuine if there was
// a userID match
if(UserIDMatch == true) {

UserIDMatch = false; // reset for next use
grantAccess(anAuthorizationLevel);
return true;

}
else return false;

} // end validate( )

} // end GroupSecurityClassTwo

Now GroupSecurityClassTwo and GroupSecurityControlClassTwo work together in the following fashion. Group security control objects according to GroupSecurityControlClassTwo kill access to resources only if they are provided a userID for a current user seeking access that matches MyUserID in their security control data and security request data fails a substantive validation against security control data. That is, group security control objects according to GroupSecurityControlClassTwo do not kill access to resources in response to request from users providing current userIDs other than the user associated with a group security control object's own MyUserID. In other words, such group security control objects only opine on validation for their own userIDs stored in MyUserID. Otherwise, they effectively pass on validation by validating. If such group security control objects find themselves asked to work on validation on behalf of a user other than the one identified in their own MyUserID, they opt out and leave the question of validation to someone else, some other group security control object or to an associated group security object instantiated, for example, from GroupSecurityClassTwo.

A group security object according to GroupSecurityClassTwo grants access only if all calls to GSCO.validate( ) succeed AND UserIDMatch is set to true. If a single validate( ) fails, access is denied. Group security control objects according to this kind of embodiment, as described above however, only check validation against their own MyUserIDs, always returning success for validate( ) calls against other userIDs. Because such group security control objects only validate against their own MyUserIDs, only one user presenting a single userID matching only one value of MyUserID is needed for validating access to a resource. The matching value of MyUserID may be present in more than one group security control object in the list, as when one user has group security control objects for a password and a thumbprint, but it still only takes one user to qualify for access. The user must pass validation for all group security control objects having the user's userID in their MyUserID fields, because any return of failure from any member validate() method will kill access. Nevertheless, any single user can gain access. There is no need to validate all users in the group for access through this kind of group security object. In other words, with reference to the method of FIG. 2, embodiments according to

GroupSecurityClassTwo and GroupSecurityControlClassTwo determine (220) access to a resource (112) by validating security request data (214) for each user-selected group security control data type (204) having in its security control data (216) a security control user identification (217) equal to the security request user identification (215).

Group membership for any particular user has the same meaning in group security objects according to GroupSecurityClassTwo as it had for GroupSecurityClassOne.

That is, a user is a member of a group if at least one group security control object contains that user's user ID in its security control data. That is, once again, the entirety of group membership. There are no group definition records, no access control tables with group identification columns, no other group-related security structures or controls at the application level. A user is a member of a group whose access to a resource is controlled through a group security object if that user's user ID is stored as a security control data element in any group security control object associated by reference with the group security object.

Again referring to FIG. 2, the illustrated method includes deploying (226) a group security object. Group security objects can be created (206) on a client device and deployed (226) to a client device (102), including the same client device on which the group security object is created, or to a server (106). Group security objects can be created (206) on a server and deployed (226) to a server (106), including the same server on which the group security object is created, or to a client device (102). Deployment can be local, that is, within the same client device or server, or within a trusted LAN.

Deployment can be remote, that is, across public networks, such as, for example, the Internet or the World Wide Web. Deployment across the web often is carried out in the form of downloads of plugins to browsers, Java RMI compliant objects, or CORBA compliant objects. One advantageous mode of remote deployment, for example, is a download of a group security object implemented as a Java applet to a Java-enabled web browser. An applet is a Java program designed to be run from another program, such as a browser, rather than directly from an operating system. Because applets typically are small in file size, cross-platform compatible, and highly secure (can't be used to access users' hard drives), they are useful for small Internet applications accessible from a browser, including, for example, group security objects according to the present invention.

More particularly, in some embodiments according to the method of FIG. 2, a resource (112) resides on a resource server (110), and the method includes deployng (226) a group security object (108) on a security server (106) and receiving (208) the request for access to the resource in a security server (106) from a client device (102) across a network (202). Network (202), as mentioned above, can be any network, public or private, local area or wide area, wireless or wired. In embodiments according to this aspect of the invention, receiving (208) a request for access (210) is typically carried out through some form of remote procedure call, such as, for example, a hyperlink to a Java servlet, a hyperlink to a CGI function, a call to a member method in a CORBA object, a remote object call through a Java RMI interface, or a remote object call through a DCOM interface.

In a further aspect of the method of FIG. 2, a resource (112) resides on a client device (102), and the client device has an application program (120 on FIG. 1c) that accesses the resource. In this kind of embodiment, the method includes deploying (226) the group security object (108) on the client device (102), effecting an architecture like the one shown in FIG. 1c. In this configuration, receiving (208) a request (210) for access to the resource (112) includes receiving (208) the request for access to the resource in the group security object itself as a call to the security method (218). In some embodiments of this kind, in fact, a group security object (108) can be compiled right into the client application (120), so that receiving a request for access is implemented as a conventional local function call, with no particular need for remote procedure calling methodologies such as those listed above-hyperlinks, CORBA, Java RMI, and so on.

In some embodiments of the present invention receiving (208) a request (210) for access to a resource (112) comprises a call to a securitymethod (218) in a group security object (108). Such direct calls can be implemented through Java, for example, by naming the security method (218) ‘main()’ and issuing a call of the form ‘java SecurityObjectName.’ Alternatively, a call maybe issued from a hyperlink in a browser to a security method in a group security object implemented as a Java servlet by including in an HTTP request message a URI of the form:

http://ServerName/servlet/MySecurityObject

where MySecurityObject is the name of a group security object implemented as a servlet and containing a security method named according to the conventions of the standard Java servlet interface, that is, for example, named ‘service().’

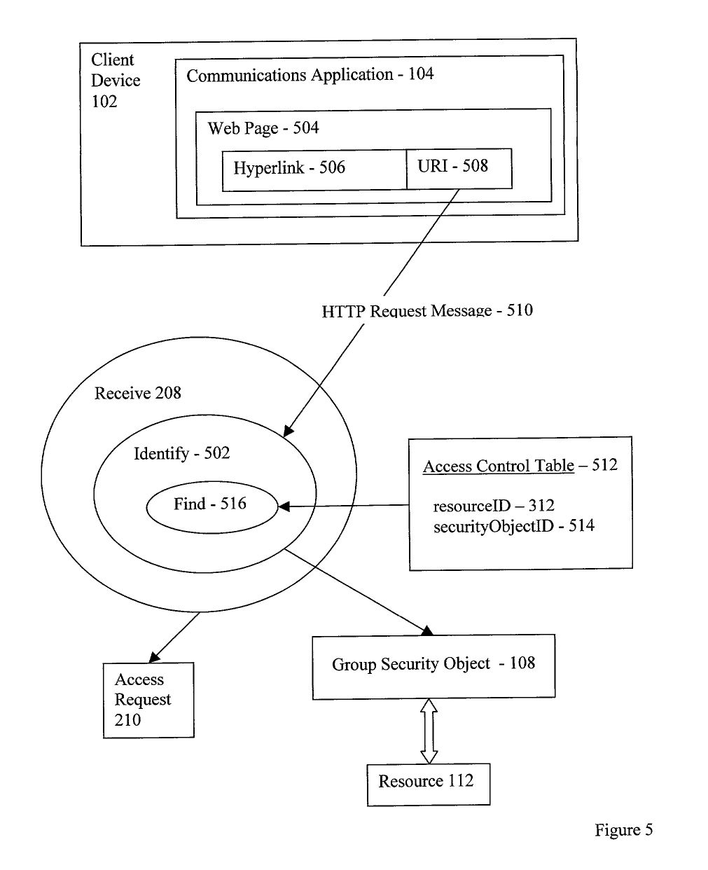

FIG. 5 sets forth a data flow diagram illustrating more detailed embodiments of receiving (208) a request (210) for access to a resource. In one method according to FIG. 5, receiving (208) a request (210) for access to a resource (112) includes identifying (502) a group security object (108), that is, identifying a group security object that controls access to the resource. Consider the example mentioned earlier of a group security object (108) implemented as a Java servlet. In such an exemplary embodiment, identifying (502) the group security object (108) comprises identifying the group security object in dependence upon a URI (508). Typically, the URI (508) originates from a hyperlink (506) in a web page (504) in a communications application (104) in a client device (102). The communications application can be, for example, a browser in a client device that is a personal computer or a microbrowser in a client device that is a web-enabled cell phone. Such embodiments typically communicate the identification of the group security object in the form of an HTTP request message containing the URI. The URI can have this form:

http://ServerName/servlet/MySecurityObject

from which a servlet-enabled server can invoke the group security object as a servlet named MySecurityObject. The server does not invoke the group security object in the sense of calling it as such. The server ‘invokes’ the group security object in that the server calls a member method within the group security object according to the conventions of the standard Java servlet interface. In this example, the identity of the group security object was known to the calling application.

It is possible, however, that the calling application may know the identity of a resource without knowing the identity of the group security object that controls access to the resource. In such an exemplary embodiment, a request for access to a secured resource may arrive in an HTTP request directed at a resource that is a document identified as:

http://ServerName/SomeoneElse'sFiles/Document123.

For use in such embodiments, in one method according to FIG. 5, identifying (502) the group security object (108) includes identifying the group security object in dependence upon a URI (508) that identifies the resource (112), including finding (516), in dependence upon the URI (508) identifying the resource (112), an identification (514) of the group security object in an access control table (512).

Although in this example, where the access request came with a URI the identification (312) of the resource is, for example, a URI or a filename or pathname extracted from a URI. In embodiments of the invention generally, there is no requirement that the communications application be a browser or use HTTP for its communications. The resource identification (312) can be any digital identification, including for example, a filename or pathname communicated in a plain text string or in cyphertext.

The identification (514) of the group security object can be the group security object name, for example, or, in the example where the group security object is implemented as a Java servlet, the identification (514) of the group security object can be a URI in the now familiar form:

http://ServerName/servlet/MySecurityobject.

In this kind of embodiment, a security server is programmed upon receiving a request for access, to check an access control table (512). In fact, this small change in the overall programming of the security server, is the only thing that makes it a ‘security server’ within the meaning of the present invention. The security server needs no other security-related service upon it. Security authentication and authorization are handled by the group security object. All the security server needs to do is look up the identity of the group security object and invoke it. ‘Invoke’ in this sense means to call the security method in the group security object by, for example, a call to ‘java SecurityObjectName’ for a group security object implemented as a standard Java class, a call to ‘http://ServerName/servlet/MySecurityObject’ for a group security object implemented as a Java servlet, or a call to ‘securityObjectName’ for a group security object implemented as a C++ program. If the security server can find no group security object for the resource identified in a request for access, then the security server continues its normal operations. If the security server is programmed to grant access only upon finding a corresponding group security object, then the security server denies access when no such object is found in the access control table. If the security server has other security services available upon it, then it is often programmed to apply them in its usual fashion.

Alternatively, if the security server has no other security services available upon it, it may be programmed to comply with HTTP request messages on their own terms according to whether they are GET messages, PUT messages, and so on. In other words, the security server can implement the standard operations of a web server. This implementation is a little riskier than the other two examples mentioned just above but it has the advantage of being very easy to implement, requiring as it does only one small change to the source code of a conventional web server just to do one lookup in an access control table and, if the lookup succeeds, invoke a group security object identified in the lookup.

By this point in this disclosure, several advantages of using various embodiments of the present invention ought are clear. One advantage is pure flexibility, especially at the user level and the application level. Embodiments of the present invention can make foundry applications available to ordinary users, rather then just to system administrators. Any user can choose to associate with any resource any kind of security data supported in a security system. Users can decide for themselves whether they want just a plain text logon ID and/or something much more elaborate—a fingerprint, a voiceprint, a retinal scan, and so on. As a result of the above, users are given greater freedom in defining the security content and security level for securing users' resources, much greater freedom than would be available in prior art systems.

Another advantage of group security objects according to the present invention is that security servers, communications servers, resource servers such as document or application servers—none of the servers in networks need to have any particular concern with security beyond associating a group security object with a resource. Moreover, as mentioned above, it is possible within the present invention to establish a regime in which all resources in a particular location are accessed only indirectly through group security objects, in which case, a server providing access to such resources need have upon it no other security service whatsoever, at least as regards authentication and authority level. In particular, servers that administer access to resources need not be concerned with the type of security data provided by users or required to qualify for access to a resource.

Another advantage of the present invention relates to encryption. Certain elements of security control data are advantageously stored in encrypted form. Persons seeking unauthorized access to resources may seek to decrypt such security control data. Such unauthorized access is made much more difficult by a need, easily established by any properly authorized user, to decrypt not only a single security control data element such as a password, but also to decrypt multiple security control data elements including fingerprints, retinal scans, voiceprints, and so on.

Another advantage is reduction of security responsibility on the part of server system administrators. This advantage obtains because group security objects of the present invention tend to upcast security control from communications protocols layers to application layers. “Layers” in this context refers to the standard data communications protocol stack in which the IP protocol resides in layer 3, the so called ‘network layer,’ and the Transmission Control Protocol, or “cp,” resides in layer 4, the so called transport layer. In this context, SSL is considered a layer 4 security protocol, and the well known protocol for virtual private networking known as “IPSec” is considered a layer 3 protocol. In this disclosure, any functionality above layer 4 is described as residing in an ‘application layer.’ Therefore group security objects according to the present invention are considered to be application layer software. As such, group security objects and their operations in securing access to resources are completely transparent to systems administrators working on layer 4 or layer 3 security systems. In fact, it is possible to structure web servers as security servers, as mentioned above, so that such security servers have little or no concern regarding whether layer 4 or layer 3 security systems even exist at all. This is potentially a dramatic shift in security responsibilities for system administrators, including, for example, system administrators in Internet Service Providers or ‘ISPs.’

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method of controlling access to a resource for a group of users, the method comprising:
creating a group security object in dependence upon one or more user-selected group security control data types, the group security object comprising security control data and at least one security method, the security control data comprising at least one security control user identification;
receiving a request for access to the resource;
receiving security request data, wherein the security request data includes at least one security request user identification; and
determining access to the resource in dependence upon the security control data and the security request data.

2. The method of claim 1 wherein creating a group security object further comprises:
storing in the group security object a resource identification for the resource;
storing in the group security object the user-selected group security control data types and the group security control data; and
storing, in the group security object, security control data for each user-selected group security control data type, including the at least one security control user identification.

3. The method of claim 2 further comprising storing in the group security object an authorization level of access for the resource, wherein determining access to the resource further comprises determining access to the resource in dependence upon the authorization level of access for the resource.

4. The method of claim 2 wherein the group security control data types comprise object oriented classes and storing the user-selected group security control data types comprises storing references to group security control objects instantiated from the group security control data types.

5. The method of claim 4 wherein storing in the group security object the at least one security control user identification further comprises storing at least one security control user identification in at least one of the group security control objects.

6. The method of claim 1 wherein the security control data comprises more than one security control user identification, receiving security request data comprises receiving more than one security request user identification, and determining access to the resource comprises validating security request data for all user-selected data types.

7. The method of claim 1 wherein determining access to the resource comprises validating security request data for each user-selected group security control data type having in its security control data a security control user identification equal to the security request user identification.

8. A system for controlling access to a resource for a group of users, the system comprising:
means for creating a group security object in dependence upon one or more user-selected group security control data types, the group security object comprising security control data and at least one security method, the security control data comprising at least one security control user identification;
means for receiving a request for access to the resource;
means for receiving security request data, wherein the security request data includes at least one security request user identification; and
means for determining access to the resource in dependence upon the security control data and the security request data.

9. The system of claim 8 wherein means for creating a group security object further comprises:
means for storing in the group security object a resource identification for the resource;
means for storing in the group security object the user-selected group security control data types and the group security control data; and
means for storing, in the group security object, security control data for each user-selected group security control data type, including the at least one security control user identification.

10. The system of claim 9 further comprising means for storing in the group security object an authorization level of access for the resource, wherein means for determining access to the resource further comprises means for determining access to the resource in dependence upon the authorization level of access for the resource.

11. The system of claim 9 wherein the group security control data types comprise object oriented classes and means for storing the user-selected group security control data types comprise means for storing references to group security control objects instantiated from the group security control data types.

12. The system of claim 11 wherein means for storing in the group security object the at least one security control user identification further comprise means for storing at least one security control user identification in at least one of the group security control objects.

13. The system of claim 8 wherein the security control data comprises more than one security control user identification, means for receiving security request data comprises means for receiving more than one security request user identification, and means for determining access to the resource comprise means for validating security request data for all user-selected data types.

14. The system of claim 8 wherein means for determining access to the resource comprises means for validating security request data for each user-selected group security control data type having in its security control data a security control user identification equal to the security request user identification.

15. A computer program product for controlling access to a resource for a group of users, the computer program product comprising:
a recording medium;
means, recorded on the recording medium, for creating a group security object in dependence upon one or more user-selected group security control data types, the group security object comprising security control data and at least one security method, the security control data comprising at least one security control user identification;
means, recorded on the recording medium, for receiving a request for access to the resource;
means, recorded on the recording medium, for receiving security request data, wherein the security request data includes at least one security request user identification; and
means, recorded on the recording medium, for determining access to the resource in dependence upon the security control data and the security request data.

16. The computer program product of claim 15 wherein means for creating a group security object further comprises:
means, recorded on the recording medium, for storing in the group security object a resource identification for the resource;
means, recorded on the recording medium, for storing in the group security object the user-selected group security control data types and the group security control data; and
means, recorded on the recording medium, for storing, in the group security object, security control data for each user-selected group security control data type, including the at least one security control user identification.

17. The computer program product of claim 16 further comprising means, recorded on the recording medium, for storing in the group security object an authorization level of access for the resource, wherein means for determining access to the resource further comprises means, recorded on the recording medium, for determining access to the resource in dependence upon the authorization level of access for the resource.

18. The computer program product of claim 16 wherein the group security control data types comprise object oriented classes and means for storing the user-selected group security control data types comprises means, recorded on the recording medium, for storing references to group security control objects instantiated from the group security control data types.

19. The computer program product of claim 18 wherein means for storing in the group security object the at least one security control user identification further comprises means, recorded on the recording medium, for storing at least one security control user identification in at least one of the group security control objects.

20. The computer program product of claim 15 wherein the security control data comprises more than one security control user identification, means for receiving security request data comprises means, recorded on the recording medium, for receiving more than one security request user identification, and means for determining access to the resource comprise means, recorded on the recording medium, for validating security request data for all user-selected data types.

21. The computer program product of claim 15 wherein means for determining access to the resource comprises means, recorded on the recording medium, for validating security request data for each user-selected group security control data type having in its security control data a security control user identification equal to the security request user identification.
